(19) United States
(12) Patent Application Publication
(10) Pub. No.: US 2012/0233319 A1
(43) Pub. Date: Sep. 13, 2012

(54) Method of Diagnostics and Monitoring Management and Related Communication Device

(76) Inventors: Ju-Ting Yang, Taoyuan County (TW); Yin-Yeh Tseng, Taoyuan County (TW)

(21) Appl. No.: 13/227,490

(22) Filed: Sep. 8, 2011

Related U.S. Application Data
(60) Provisional application No. 61/380,710, filed on Sep. 8, 2010.

(51) Int. Cl. H04W 24/00; G06F 15/173

(52) U.S. Cl. 709/224

(57) ABSTRACT

A method of diagnostics and monitoring management for a DM (device management) client in a wireless communication system is disclosed. The method comprises having at least one event set in a Trap management object (MO) tree; and performing measurements and providing measurement results to the server when the at least one event is triggered.

### CROSS REFERENCE TO RELATED APPLICATIONS

This application claims the benefit of U.S. Provisional Application No. 61/380,710 filed on Sep. 8, 2010 and entitled “Event-Triggered Radio Measurement Collections for Minimization of Drive Tests and Network Planning Optimization”, the contents of which are incorporated herein.

### BACKGROUND OF THE INVENTION

1. Field of the Invention

The application relates to a method and a related communication device used in a wireless communication system and related communication device, and more particularly, to a method of diagnostics and monitoring management and a related communication device in a wireless communication system.

2. Description of the Prior Art

Open Mobile Alliance (OMA) is the focal point for the development of mobile service enabler specifications, which support the creation of interoperable end-to-end mobile services. OMA drives service enabler architectures and open enabler interfaces that are independent of the underlying wireless networks and platforms. OMA creates interoperable mobile data service enablers that work across devices, service providers, operators, networks, and geography. Toward that end, OMA will develop test specifications, encourage third party tool development, and conduct test activities that allow vendors to test their implementations.

In OMA DM (Device Management) working group, DiagMon (Diagnostics and Monitoring) is defined to manage distributed, mobile wireless devices, in order to optimize a subscriber's experience and reduce network operating costs.

The overall goal of DM device diagnostics and monitoring is to enable management authorities to proactively detect and repair troubles even before the users are impacted, or to determine actual or potential problems with a device when an opportunity presents itself. A management authority is an entity that has the right to perform a specific DM function on a device or manipulate a given data element or parameter.

The generic management interface for DiagMon functions can be broadly divided into two parts: the DiagMon Management Objects (DiagMonMOs) and alert message. Through this interface a server can configure or invoke the functions behind it, and retrieve results of Diagnostics or monitored information. Note that this interface framework does not present any specific function. Instead, it is intended to be used to define a wide range of DiagMon functions. For this purpose, all the different Diagnostics and Monitoring Functions will have its own MO Identifiers which is used to identify the function represented by this framework. With this identifier, the server is able to get further information of the function.

A DiagMon function is resident on DM device. The DiagMonMO makes this function remotely callable by the Diagnostics and Monitoring System. The DiagMonMO is used as the means to expose the Diagnostic and Monitoring function to the Diagnostics and Monitoring System. The DiagMonMO will provide the following management capabilities and diagnostics and monitoring operations: Invoke the Diagnostics and Monitoring functions; Stop the Diagnostics and Monitoring functions; Configure the Diagnostics and Monitoring functions for reporting, execution, etc.; Retrieves the Diagnostics and Monitoring data or the results; Notifications using the Generic Alert.

A trap is a well known concept employed in network management. It is a mechanism employed by a management authority to enable the device to capture and report events and other relevant information generated from various components of the Device, such as a protocol stack, device drivers, or applications. The Trap MO (Management Object) framework defined in this specification will be used for specific Trap MOs to be defined and uniquely identified by a Trap ID.

In OMA DM Device Diagnostics and monitoring, a management authority is expected to proactively detect and repair troubles for users to provide better functionalities. Besides, DiagMon function is also expected to minimize the costly efforts of drive tests for better network planning optimization. However, In current DiagMon design, even some trap event logging and panic logging functionality are defined; they are not utilized fully and reported proactively to DM Servers.

In addition, DM clients can also collect valuable measurement reports when certain events happened to servers, which is definitely helpful for servers to provide better network coverage avoiding some undesired network defect, such as weak coverage area, coverage hole, coverage mapping.

### SUMMARY OF THE INVENTION

A method of diagnostics and monitoring management for a DM (device management) client in a wireless communication system is provided.

A method of diagnostics and monitoring management for a DM client in a wireless communication system is disclosed. The method comprises having at least one event set in a Trap management object (MO) tree; and performing measurements and providing measurement results to the server when the at least one event is triggered.

A method of diagnostics and monitoring management for a DM server in a wireless communication system is disclosed. The method comprises creating a Trap MO in a DM client; and setting at least one event in a Trap MO tree of the Trap MO.

A communication device for diagnostics and monitoring management in a wireless communication system is disclosed. The communication device comprises means for having at least one event set in a Trap MO tree; and means for performing measurements and providing measurement results to the server when the at least one event is triggered.

A communication device for diagnostics and monitoring management in a wireless communication system is disclosed. The communication device comprises means for creating a Trap MO in a DM client; and means for setting at least one event in a Trap MO tree of the Trap MO.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary architecture of a wireless communication system.

FIG. 2 is a schematic diagram of an exemplary communication device.

FIG. 3 is a flow chart of an exemplary process.

### DETAILED DESCRIPTION

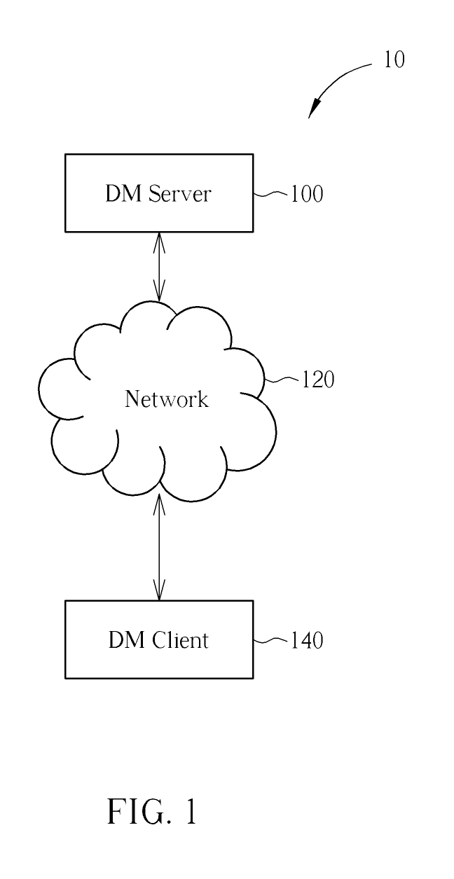

Please refer to FIG. 1, which is an exemplary architecture of a wireless communication system 10. The wireless communication system 10 complies with a DM (Device Management) protocol specified by Open Mobile Alliance (OMA) DM working group. The wireless communication system 10 includes a DM server 100, a network 120 and a DM client 140. The device management takes place by communication between the DM server 100 and the DM client 140. The DM client 140 can initiate communication. Once the communication is established between the DM server 100 and the DM client 140, a sequence of messages might be exchanged to complete a given device management task. OMA DM provides for alerts, which are messages that can occur out of sequence, and can be initiated by either server or client. Such alerts are used to handle errors, abnormal terminations etc.

The network 120 could be 3GPP (the third generation partnership project) network, such as a long-term evolution-Advanced (LTE-A) system, a HSPA+ (High Speed Packet Access Plus) system) or other mobile communication systems (e.g. LTE, WCDMA, HSPA, GSM, EDGE, etc.), considered a new radio interface and radio network architecture that provides a high data rate, low latency, packet optimization, and improved system capacity and coverage. In addition, the network 120 could be a wire line network as well.

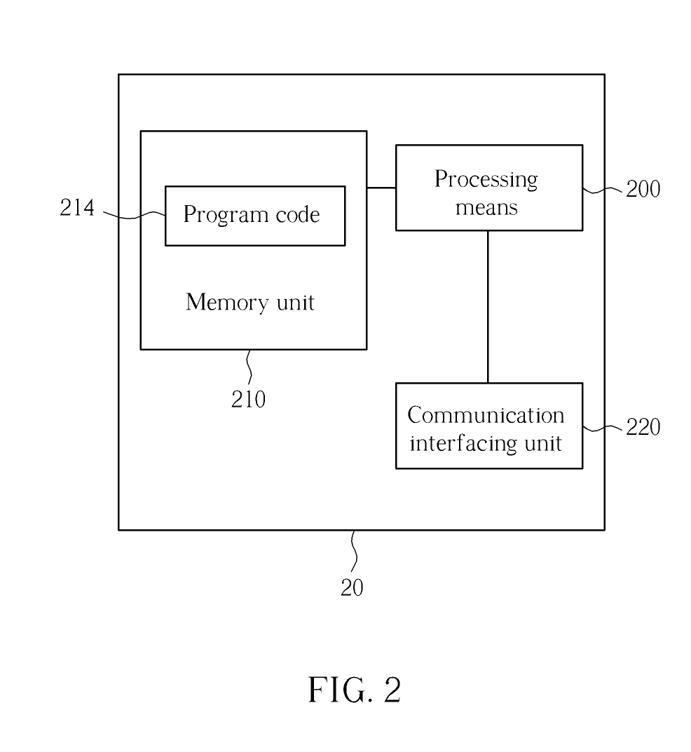

Please refer to FIG. 2, which is a schematic diagram of an exemplary communication device 20. The communication device 20 can be the DM server 100 or the DM client 140 shown in FIG. 1 and may include a processing means 200 such as a microprocessor or ASIC, a memory unit 210, and a communication interfacing unit 220. The memory unit 210 may be any data storage device that can store program code 214 for access by the processing means 200. Examples of the memory unit 210 include but are not limited to a subscriber identity module (SIM), read-only memory (ROM), random-access memory (RAM), CD-ROMs, and optical data storage devices. The communication interfacing unit 220 is preferably a radio transceiver for wirelessly communicating with the network according to processing results of the processing means 200.

A Diagnostics and Monitoring (DiagMon) function performs various diagnostics and monitoring activities in order to diagnose problems, report data, or collect measurements data associated with a device, with applications on a DM device (e.g. the DM client 140), with the network 120 in which the device operates or with access to services provided by the network 120.

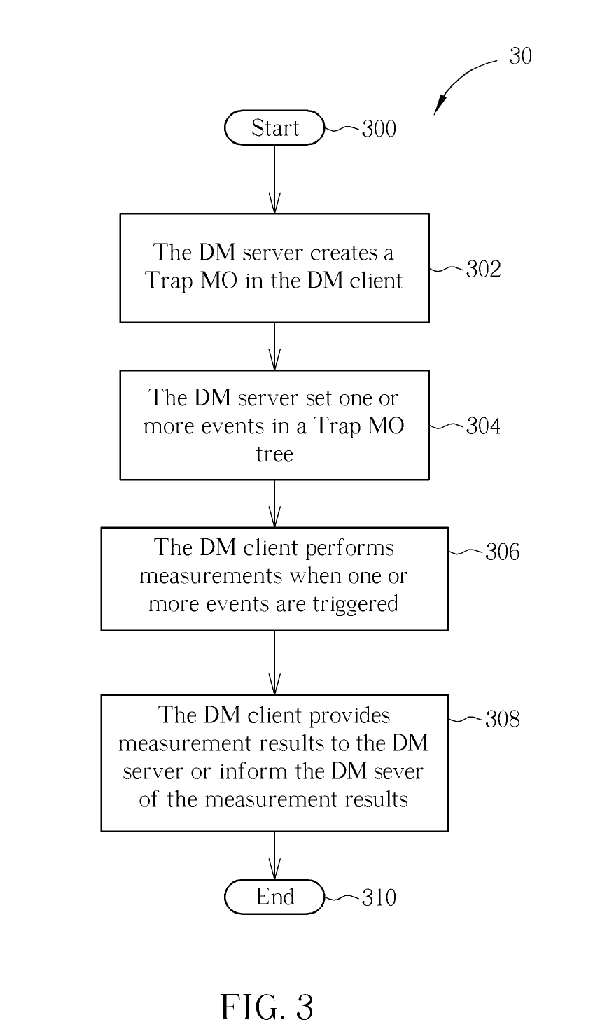

Please refer to FIG. 3, which is a flow chart of an exemplary process 30. The process 30 is used for the DM server 100 and the DM client 140 in the wireless communication system 10. The process 30 can be compiled into the program code 214 and include the following steps:

Step 300: Start.

Step 302: The DM server 100 creates a Trap MO in the DM client 140.

Step 304: The DM server 100 set one or more events in a Trap MO tree.

Step 306: The DM client 140 performs measurements when one or more events are triggered.

Step 308: The DM client 140 provides measurement results to the DM server 100 or inform the DM sever 100 of the measurement results.

Step 310: End.

According to the process 30, the Trap MO is involved. The DM server 100 creates the Trap MO in the DM client 140, for example in a memory of the DM client 140. The DM server 100 sets one or more events in the Trap MO tree of the Trap MO. For example, one or more event set in the Trap MO tree could be an unstable radio frequency (RF) environment even (such as: an abrupt SIR drop event, poor air condition including poor RSSI, RSCP, SIR event)/an event of consecutive radio link control (RLC) unrecoverable errors/a radio link failure event. When one or more events are triggered, the DM client 140 performs the measurements. The DM client 140 provides the measurement results to the DM server 100 or informs the DM sever 100 of the measurement results. If the DM client 140 informs the DM server 100 of the measurement results, the DM server 100 can decide whether to request the measurement results from the DM client 140. In other words, when the RF environment of the network 120 is not stable (is poor) or when the network 120 has radio link failure, one or more events will be triggered. Meanwhile, the DM client 140 performs the measurements and provides the measurement results to the DM server 100 or informs the DM sever 100 of the measurement results. If the DM client 140 informs the DM server 100 of the measurement results, the DM server 100 can decide whether to request the measurement results from the DM client 140. After the DM server 100 gets the measurement results, the DM server 100 can make use of the measurement radio information to provide better network coverage to reduce possible radio link failure.

Preferably, the DM client 140 performs the measurement by requesting a modem. The modem is connected to the DM client 140, performing the measurements. Then, the DM client 140 obtains the measurement results from the modem and sends the measurement results to the DM server 100.

The DM client 140 can provide the measurement results by establishing a DM session with the DM server 100. In some examples, the DM client 140 sends a generic alert to the DM server 100 to notify the DM server 100 of the measurement results. Then the DM server 100 can decide whether to request the measurement results from the DM client 140. Also, the DM client 140 sends the generic alert to the DM server 100 to notify a radio link failure. In some examples, the DM client 140 can interact with a user by popping up a message to ask the user whether the user wants to provide the DM server 100 with the measurement results. With the useful measurement results collected, the DM server 100 can provide better network coverage to reduce possible radio link failure.

Please note that the abovementioned steps including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20 in which the processing means 200 processes the program code 214 related to the abovementioned processes and the processed results can handling diagnostics and monitoring management in the wireless communication system 10.

To sum up, the DM server firstly creates the Trap MO in the DM client 140, and then sets one or more events in the Trap MO tree of the Trap MO. When one or more events are triggered, the DM client performs measurements. The DM client 140 provides the measurement results to the DM server 100 or informs the DM sever 100 of the measurement results. If the DM client 140 informs the DM server 100 of the measurement results, the DM server 100 can decide whether to request the measurement results from the DM client 140. After the DM server gets the measurement results, the DM server 100 can provide better network coverage to reduce possible radio link failure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of diagnostics and monitoring management for a DM (device management) client in a wireless communication system, the method comprising:
having at least one event set in a Trap management object (MO) tree;
performing measurements when the at least one event is triggered; and
providing measurement results to a server or informing the sever of the measurement results.

2. The method of claim 1, wherein the wireless communication system complies with an Open Mobile Alliance (OMA) specification.

3. The method of claim 1, wherein providing the measurement results to the server comprises sending the measurement results by establishing a DM session with the server.

4. The method of claim 1, wherein the at least one event comprises at least one of an unstable radio frequency (RF) environment event, a consecutive radio link control (RLC) errors and a radio link failure event.

5. The method of claim 1 further comprising sending a generic alert to the server to notify the server of the measurement results.

6. The method of claim 1 further comprising popping up a message to a user, wherein the message indicates to the user whether to send the measurement results to the server.

7. The method of claim 1, wherein performing the measurement comprises requesting a modem to perform the measurement.

8. The method of claim 7 further comprising obtaining the measurement results from the modem.

9. A method of diagnostics and monitoring management for a DM (device management) server in a wireless communication system, the method comprising:
creating a Trap management object (MO) in a DM client; and
setting at least one event in a Trap MO tree of the Trap MO.

10. The method of claim 9, wherein the wireless communication system complies with am Open Mobile Alliance (OMA) specification.

11. The method of claim 9, wherein the at least one event comprises at least one of an unstable radio frequency (RF) environment event, a consecutive radio link control (RLC) errors and a radio link failure event.

12. A communication device for diagnostics and monitoring management in a wireless communication system, the communication device comprising:
means for having at least one event set in a Trap management object (MO) tree; and
means for performing measurements when the at least one event is triggered; and
means for providing measurement results to a server or informing the sever of the measurement results.

13. The communication device of claim 12, wherein the wireless communication system complies with am Open Mobile Alliance (OMA) specification.

14. The communication device of claim 12, wherein providing the measurement results to the server comprises sending the measurement results by establishing a DM session with the server.

15. The communication device of claim 12, wherein the at least one event comprises at least one of an unstable radio frequency (RF) environment event, a consecutive radio link control (RLC) errors and a radio link failure event.

16. The communication device of claim 12 further comprising means for sending a generic alert to the server to notify the server of the measurement results.

17. The communication device of claim 12 further comprising means for popping up a message to a user, wherein the message indicates to the user whether to send the measurement results to the server.

18. The communication device of claim 12, wherein performing the measurement comprises requesting a modem to perform the measurement.

19. The communication device of claim 18 further comprising means for obtaining the measurement results from the modem.

20. A communication device for diagnostics and monitoring management in a wireless communication system, the communication device comprising:
means for creating a Trap management object (MO) in a DM client; and
means for setting at least one event in a Trap MO tree of the Trap MO.

21. The communication device of claim 20, wherein the wireless communication system complies with am Open Mobile Alliance (OMA) specification.

22. The communication device of claim 20, wherein the at least one event comprises at least one of an unstable radio frequency (RF) environment event, a consecutive radio link control (RLC) errors and a radio link failure event.
